(19) United States
(12) Patent Application Publication
(10) Pub. No.: US 2006/0197450 A1
(43) Pub. Date: Sep. 7, 2006

(54) Dielectric layer structure and plasma display panel having the same

(76) Inventor: Jae-Ik Kwon, Suwon-si (KR)

Correspondence Address: Robert E. Bushnell, Suite 300, 1522 K Street, N.W., Washington, DC, 20005, US

(21) Appl. No.: 11/356,218

(22) Filed: Feb. 17, 2006

(30) Foreign Application Priority Data
Mar. 3, 2005 (KR) 10-2005-0017550

(51) Int. Cl. H01J 17/49

(52) U.S. Cl. 313/586; 313/587; 313/582

(57) ABSTRACT

A dielectric layer structure with grooves is provided in a plasma display panel to form the dielectric layer in an optimum shape maximizing a size of a discharge space and enhancing emission brightness and the discharge efficiency. The dielectric layer structure comprises barrier ribs defining discharge cells, a phosphor layer located inside the discharge cells, and a dielectric layer in which a groove is formed inside the discharge cell on which the phosphor layer is formed.

### CLAIM OF PRIORITY

This application makes reference to, incorporates the same herein, and claims all benefits accruing under 35 U.S.C. §119 from an application for STRUCTURE OF DIELECTRIC LAYER FOR PLASMA DISPLAY PANEL AND PLASMA DISPLAY PANEL COMPRISING THE SAME earlier filed in the Korean Intellectual Property Office on the 3 of Mar. 2005 and there duly assigned Serial No. 10-2005-0017550.

### BACKGROUND OF THE INVENTION

1. Field of the Invention

The present invention relates to a plasma display panel, and more particularly to a dielectric layer structure in a plasma display panel, which can be formed in the optimum shape to maximize a discharge space and enhance emission brightness by providing grooves in the dielectric layer, and a plasma display panel having the dielectric layer structure.

2. Description of the Related Art

Plasma display panels (PDPs) are flat display devices which display images using a gas discharge phenomenon. PDPs have recently received much attention since they can be made very large and thin while providing a wide viewing angle and high image quality.

A plasma display panel includes a front substrate and a rear substrate. Pairs of sustain electrodes including a common electrode and a scan electrode are located on the front substrate, and address electrodes are located on the rear substrate to intersect the pairs of sustain electrodes.

A dielectric layer is stacked on the rear substrate to cover the address electrodes, and barrier ribs are formed on the dielectric layer to define discharge cells. The dielectric layer is formed after the address electrodes are formed. Therefore, the dielectric layer has the protrusions on the surface caused by the address electrodes. When a phosphor layer is formed on the dielectric layer, the phosphor layer has convex portions due to the protrusions formed on the dielectric layer.

Therefore, the surface of the phosphor layer is not uniform, which causes a problem that charged particles collide with the convex portion more than any other portion of the phosphor layer. The non-uniformity of the phosphor layer also makes a plasma display panel have low emission brightness and poor discharge efficiency.

### SUMMARY OF THE INVENTION

The present invention provides a dielectric layer structure in a plasma display panel in which the dielectric layer is formed in the optimum shape to maximize a size of discharge space and to enhance emission brightness by providing a groove in the dielectric layer, and a plasma display panel having the dielectric layer structure.

According to an aspect of the present invention, there may provided a dielectric layer structure in a plasma display panel, the structure with barrier ribs defining discharge cells, a dielectric layer forming a portion of a side of the discharge cell, a groove formed on the dielectric layer, and a phosphor layer formed inside discharge cell.

The groove may be centered between the barrier ribs. The groove may have an edge portion and a bottom portion. The edge portion may have an inclined plane formed at an angle with respect to the bottom portion. A cross-section of the edge portion may have a step shape. A cross-section of the edge portion may have an arc shape. The groove may be symmetrical about a center of the discharge cell. The groove maybe continuously formed through the discharge cells. The groove may be individually formed in each of the discharge cells.

According to another aspect of the present invention, there may be provided a plasma display panel with a first substrate, a second substrate parallel to the first substrate, barrier ribs located between the first substrate and the second substrate to define discharge cells together with the first substrate and the second substrate, sustain electrodes having a common electrode and a scan electrode for performing discharge in the discharge cells, address electrodes extending in a direction intersecting the sustain electrodes, a dielectric layer which covers the address electrodes, a groove formed on the dielectric layer inside the discharge cell, a phosphor layer formed inside the discharge cell and formed on the dielectric layer, and discharge gas contained in the discharge cell.

The first substrate may be transparent. The common electrode and the scan electrode may be located inside the barrier ribs, and may be spaced apart from each other. The groove may be centered between the barrier ribs. The groove may have an edge portion and a bottom portion. The edge portion may have an inclined plane formed at an angle with respect to the bottom portion. A cross-section of the edge portion may have a step shape. A cross-section of the edge portion may have an arc shape. The groove may be symmetrical about a center of the discharge cell. The groove may be continuously formed through the discharge cells. The groove may be individually formed in each of the discharge cells.

### BRIEF DESCRIPTION OF THE DRAWINGS

A more complete appreciation of the invention and many of the attendant advantages thereof, will be readily apparent as the same becomes better understood by reference to the following detailed description when considered in conjunction with the accompanying drawings in which like reference symbols indicate the same or similar components, wherein:

FIG. 1 is a cross-sectional view of an AC type three-electrode surface discharge plasma display panel;

FIG. 2 is an exploded perspective view of a plasma display panel constructed as a first embodiment of the present invention;

FIG. 3 is a cross-sectional view taken along Line III-III of FIG. 2;

FIG. 4 is across-sectional view of a plasma display panel accordingto a modified example of the first embodiment of the present invention;

FIG. 5 is an exploded perspective view of a plasma display panel constructed as a second embodiment of the present invention; and

FIG. 6 is a cross-sectional view taken along Line VI-VI of FIG. 5.

### DETAILED DESCRIPTION OF THE INVENTION

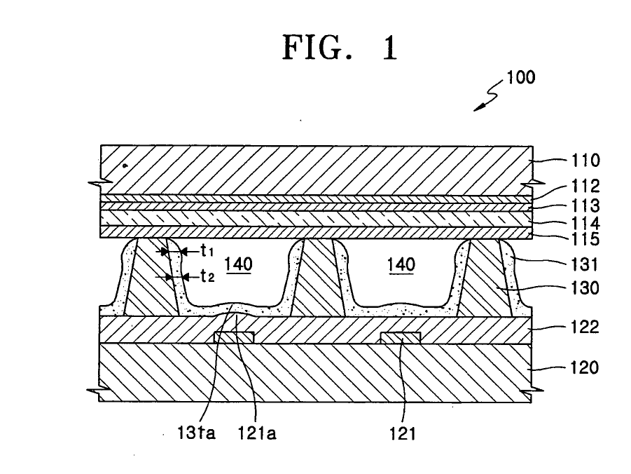

FIG. 1 is a cross-sectional view of an AC type three-electrode surface discharge plasma display panel. As shown in FIG. 1, plasma display panel 100 includes a front panel 110 and a rear panel 120. The front panel 110 is made of a transparent material. Pairs of sustain electrodes 112 including a common electrode and a scan electrode are located on the front panel 110, and bus electrodes 113 are located below the sustain electrodes. A first dielectric layer 114 is stacked below the bus electrodes 113, and a protective layer 1 15 is stacked below the first dielectric layer 114.

Address electrodes 121 are located on the rear panel 120 to intersect the pairs of sustain electrodes 112, and a second dielectric layer 122 is stacked thereon to cover the address electrodes 121. Barrier ribs 130 are formed on the front surface of the second dielectric layer 122. A phosphor layer 131 is formed on both side walls of the barrier ribs 130 and on the front surface of the second dielectric layer 122 covering an area where the barrier ribs 130 are not formed. Generally, the phosphor layer 131 is made of a viscous phosphor paste.

The second dielectric layer 122 is formed after the address electrodes 121 are formed, which causes micro convex portions 121a to be formed on the second dielectric layer 122. The phosphor layer 131 is formed on the second dielectric layer 122. In spite of the surface tension of the phosphor paste, the phosphor layer 131 also has convex portions 131a due to the convex portions 121a of the second dielectric layer 122.

The phosphor layer 131 is generally formed by printing. In this case, because the phosphor paste forming the phosphor layer 131 does not naturally flow downward due to the structure of the second dielectric layer 122, the thickness t₁ of the phosphor layer located on the side surfaces of the upper portions of the barrier ribs 130 is greater than the thickness t₂ of the phosphor layer located on the side surfaces of the middle portions of the barrier ribs 130.

Therefore, the plasma display panel 100 has a problem that plasma collides with the convex portions 131a of the phosphor layer and the thick portions of the phosphor layer 131 on the upper side surfaces of the barrier ribs 130. In addition, the plasma display panel 100 has a problem that the emission brightness and the discharge efficiency decrease, because the actual size of the discharge spaces of the discharge cells 140, which is designed for discharge, is smaller than a size of the originally designed discharge space.

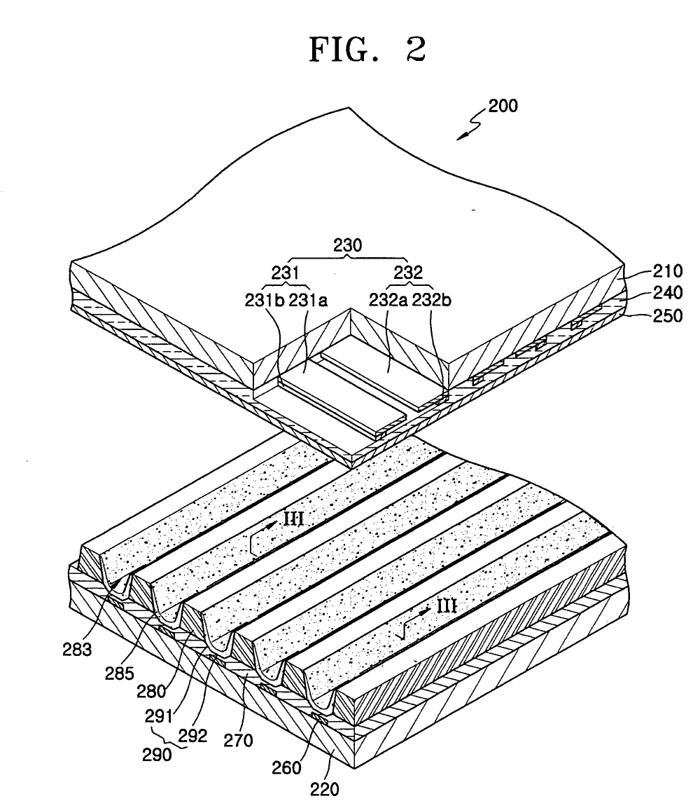

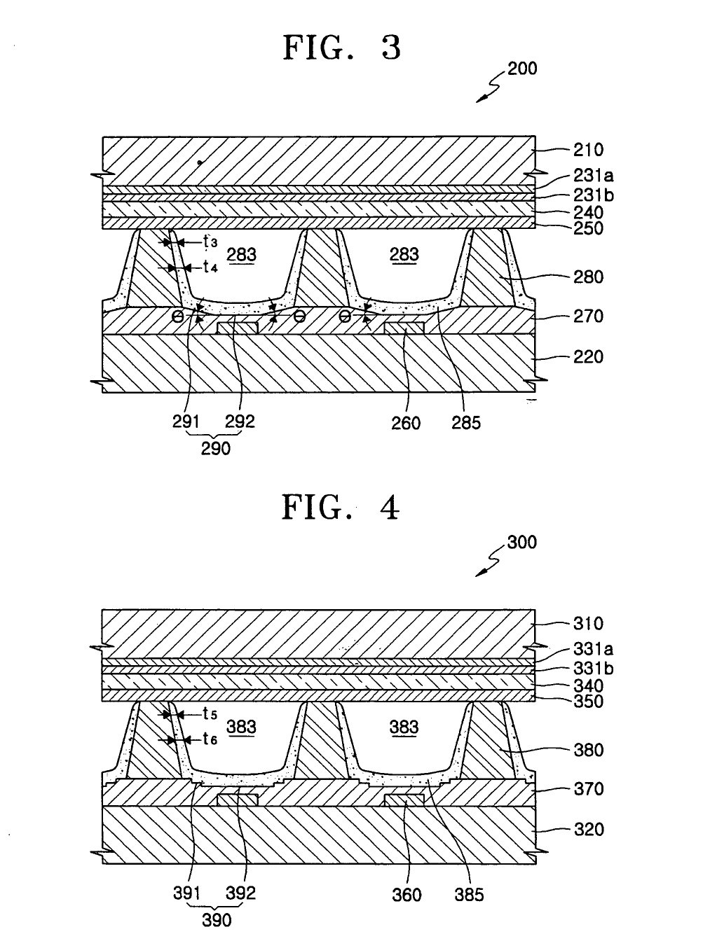

FIG. 2 is an exploded perspective view of a plasma display panel built as a first embodiment of the present invention, and FIG. 3 is a cross-sectional view taken along Line III-III of FIG. 2. As shown in FIGS. 2 and 3, a plasma display panel 200 includes a first substrate 210 and a second substrate 220 parallel to and spaced apart from the first substrate 210.

The first substrate 210 and the second substrate 220 define a plurality of discharge cells 283 partitioned by barrier ribs 280. The first substrate 210 is made of transparent glass. Pairs of sustain electrodes including a common electrode 231 and a scan electrode 232 are located on the first substrate 210. The common electrode 231 includes a transparent electrode 231a and a bus electrode 231b. The scan electrode 232 includes a transparent electrode 232a and a bus electrode 232b. The transparent electrodes 231a and 232a are made of ITO (Indium Tin Oxide).

In the first embodiment, pairs of sustain electrodes 230 are located on the rear surface of the first substrate 210. However, the location of the pairs of sustain electrodes is not limited to this structure, and the pairs of sustain electrodes may be spaced apart from the first substrate 210. The pairs of sustain electrodes may be located inside the barrier ribs 280. In this case, the electrodes can be made of metal having higher conductivity and lower resistance, such as silver, aluminum, or copper, instead of the transparent electrode.

A first dielectric layer 240 is stacked on the rear surface of the first substrate 210 to cover the pairs of sustain electrodes 230. The first dielectric layer 240 may prevent the common electrodes 231 and the scan electrodes 232 from being directly electrically connected during the discharge, may prevent charged particles from directly colliding with and damaging the pairs of sustain electrodes 230, and may induce the charged particles to accumulate wall charges. The first dielectric layer 240 is made of lead oxide (PbO), boron oxide (B₂O₃), or silica (SiO₂). A protective layer 250 is formed on the rear surface of the first dielectric layer 240.

The protective layer 250 prevents positive ions and electrons from colliding with the first dielectric layer 240 and from damaging the first dielectric layer 240 during the discharge. In addition, the protective layer 250 emits a large amount of secondary electrons to help discharge. Therefore, the protective layer 250 is made of magnesium oxide (MgO), which has a high visible ray transmittance and a high secondary electron emission coefficient.

Address electrodes 260 are located on the front surface of the second substrate 220 crossing the pairs of sustain electrodes 230. A second dielectric layer 270 is formed on the address electrodes 260, and prevents charged particles from directly colliding with and damaging the address electrodes 260. The second dielectric layer 270 is made of lead oxide (PbO), boron oxide (B₂O₃), or silica (SiO₂) like the first dielectric layer 240.

Barrier ribs 280 are formed on the front surface of the second dielectric layer 270. The barrier ribs in the present embodiment are formed as open stripes. However, the present invention is not limited to this type of rib, and the horizontal cross-section of the discharge cells may have a polygonal shape such as a rectangular, a triangular, or a pentagonal pattern, or may have a closed pattern such as a circle or an ellipse.

Grooves 290 are formed in portions of the second dielectric layer 270 between the barrier ribs 280 defining the discharge cells 283. The grooves 290 are positioned at the center between the barrier ribs 280. Each groove 290 has an edge portion 291 and a bottom portion 292, and is formed by pattern printing. The edge portion 291 has an inclined plane shape forming an angle θ with respect to the bottom portion 292. The bottom portion 292 is parallel to the front surface of the second substrate 220. Since the shape of the edge portion 291 is symmetrical in each discharge cell 283, the shape of the groove 290 is symmetrical about a center of a discharge cell 283.

The grooves 290 are continuously formed along the address electrodes 260, and cross the discharge cells 283. Although the grooves 290 are formed along the address electrodes 260 in the present embodiment, the present invention is not limited to this arrangement. That is, the grooves of the present invention may be individually formed in each discharge cell 283 being disconnected from other grooves.

The phosphor layer 285 is formed on side surfaces of the barrier ribs 280 and on the second dielectric layer 270 forming the discharge cells 283. The phosphor layer 285 has an ingredient which generates visible rays in response to ultraviolet rays. A red phosphor layer formed in the red light-emitting discharge cells contains a phosphor substance such as Y(V,P)O₄:Eu; a green phosphor layer formed in the green light-emitting discharge cells contains a phosphor substance such as Zn₂SiO₄:Mn; and a blue phosphor layer formed in the blue light-emitting discharge cells contains a phosphor substance such as BAM:Eu.

The phosphor layers 285 are formed by screen printing. That is, a viscous phosphor paste is applied to the side surfaces of the barrier ribs 280, and flows down the side surfaces of the barrier ribs 280 covering the edge portions 291 and the bottom portions 292 of the grooves 290. Thereafter, the coated phosphor paste is made uniform by surface tension forming the phosphor layers 285.

At this time, the phosphor layers 285 of the plasma display panel 200 are reliably formed by the shape of the grooves 290. That is, the phosphor layers 285 formed on the bottom portions 292 of the grooves 290 are concave due to the shape of the bottom portions 292. Accordingly, no convex portion exists. In addition, the phosphor paste easily flows down the barrier ribs to form phosphor layers due to the shape of the edge portions 291 having the inclined plane shape. As shown in FIG. 3, the thickness t₃ of the phosphor layer 285 at the top of the barrier ribs is smaller than the thickness t₄ of the phosphor layer 285 at the middle portion of the barrier ribs 280. As a result, it is possible to maximize a size of the discharge space in the discharge cells 283. After the first substrate 2 1 0 and the second substrate 220 are assembled to each other with frit glass, a discharge gas such as neon (Ne), xenon (Xe), or a mixture gas thereof is filled into the discharge cells 283.

An exemplary discharge process of the plasma display panel 200 according to the first embodiment of the present invention having the above structure is described as follows.

First, when an address voltage is applied between the address electrodes 260 and the scan electrodes 232 from an external power source, address discharge is generated. Then, the discharge cells in which sustain discharge should be generated are selected as a result of the address discharge.

Thereafter, when a discharge sustain voltage is applied between the common electrode 231 and the scan electrode 232 of the selected discharge cells, a sustain discharge is created by migrations of wall charges accumulated on the common electrode 231 and the scan electrode 232. As the energy level of the discharge gas excited by the sustain discharge drops, ultraviolet rays are emitted.

The ultraviolet rays excite the phosphor substance of the phosphor layer 285 coated in the discharge cells 283. When the energy level of the phosphor substance of the phosphor layer 285 drops, visible rays are emitted. The emitted visible rays exit through the first substrate 2 1 0 to form the visible image.

Specifically, the grooves 290 of the plasma display panel 200 formed according to the first embodiment make the phosphor layer 285 formed on the bottom portions 292 have overall concave shapes. Accordingly, there are no convex portions protruding into the discharge cells 283. In addition, because the thickness t₃ of the phosphor layers 285 formed at the top of the barrier ribs 280 is smaller than the thickness t₄ of the phosphor layers 285 formed at the middle portion of the barrier ribs 280, it is possible to maximize the size of the discharge spaces in the discharge cells 283. As a result, the plasma discharge becomes easier, thereby enhancing the emission brightness and the discharge efficiency.

A modified example of the first embodiment of the present invention will now be described with reference to FIG. 4. The description focuses mainly on the differences from the first embodiment.

FIG. 4 is a cross-sectional view of a plasma display panel constructed according to a modified example of the first embodiment of the present invention.

As shown in FIG. 4, the plasma display panel 300 having a dielectric layer structure according to a modified example of the first embodiment of the present invention may be constructed with a first substrate 310, a second substrate 320, pairs of sustain electrodes including a common electrode 331 and a scan electrode (not shown), transparent electrodes 331a, bus electrodes 331b, a first dielectric layer 340, a protective layer 350, address electrodes 360, a second dielectric layer 370, barrier ribs 380, discharge cells 383, phosphor layers 385, and grooves 390.

The grooves 390 are formed in the second dielectric layer 370 centered between the barrier ribs 380. Each groove 390 has an edge portion 391 and a bottom portion 392, and is formed by pattern printing. The edge portion 391 has a step shape, unlike the edge portion 291 of the first embodiment. However, the bottom portion 392 has a horizontal plane shape like the bottom portion 292 of the first embodiment. The edge portion 391 built according to the modified example of the first embodiment has a step shape with two steps, but the present invention is not limited to this number of steps. That is, the number of steps of the step shape is not limited, and as long as forming of the edge portions 391 is convenient, any number of steps may be used, such as 3, 4, or 5.

The plasma display panel 300 having a dielectric layer structure built according to a modified example of the first embodiment of the present invention has the same structure as the first embodiment, except for the shape of the grooves 390, and thus the detailed description of the common elements will be omitted.

The grooves 390 formed in the second dielectric layer 370 of the plasma display panel 300 according to the modified example of the first embodiment make the phosphor layers 385 have an overall concave shape on the bottom portions 392. Accordingly, no convex portion exists. In addition, the grooves 390 make the thickness t₅ of the phosphor layer 385 at the top of the barrier ribs smaller than the thickness t₆ of the phosphor layer 385 at the middle portion of the barrier ribs 380. As a result, it is possible to maximize a size of the discharge space in the discharge cells 383, thereby enhancing the emission brightness and the discharge efficiency.

Furthermore, because the edge portions 391 in the modified example of the first embodiment are formed in a step shape, the edge portions 391 can be more easily formed using the pattern printing method, thereby making the process of forming the edge portion simple.

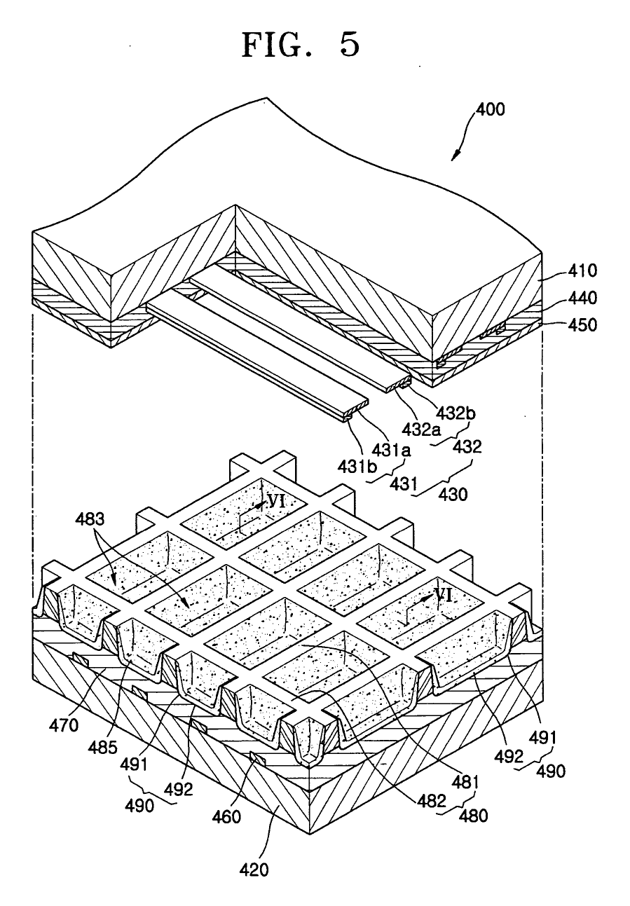

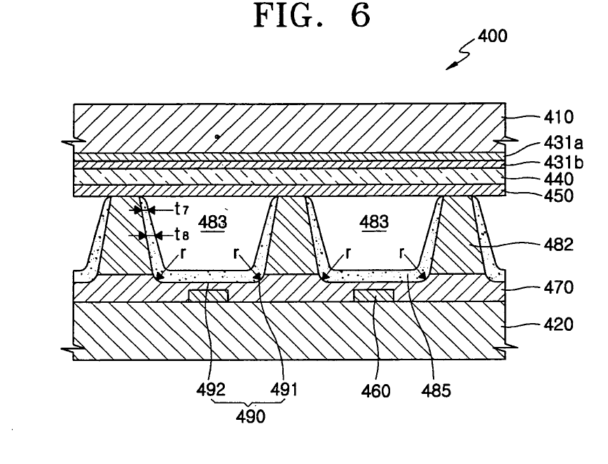

A second embodiment of the present invention will now be described with reference to FIGS. 5 and 6. FIG. 5 is an exploded perspective view of a plasma display panel constructed as a second embodiment of the present invention, and FIG. 6 is a cross-sectional view taken along Line VI-VI of FIG. 5.

As shown in FIGS. 5 and 6, a plasma display panel 400 according to the second embodiment of the present invention includes a first substrate 410 and a second substrate 420 parallel to and spaced apart from the first substrate 410. The first substrate 410 and the second substrate 420 define a plurality of discharge cells 483 partitioned by barrier ribs 480. The first substrate 410 is made of transparent glass.

Pairs of sustain electrodes 430 including a common electrode 431 and a scan electrode 432 are located on the first substrate 410. The common electrode 431 includes a transparent electrode 431a and a bus electrode 431b. The scan electrode 432 includes a transparent electrode 432a and a bus electrode 432b. The transparent electrodes 431a and 432a are made of ITO (Indium Tin Oxide).

In the second embodiment, pairs of sustain electrodes 430 are located on the rear surface of the first substrate 410. However, the location of the pairs of sustain electrodes 430 is not limited to this structure, and the sustain electrodes 430 maybe spaced apart from the first substrate 410. The pairs of sustain electrodes 430 may be located inside the barrier ribs 480. In this case, the electrodes can be made of metal having higher conductivity and lower resistance, such as silver, aluminum, or copper, instead of the transparent electrode.

A first dielectric layer 440 is stacked on the rear surface of the first substrate 410 to cover the pairs of sustain electrodes 430. The function and material of the first dielectric layer 440 are similar to those of the first dielectric layer 240 of the first embodiment, and thus the description thereof will be omitted.

A protective layer 450 is formed on the first dielectric layer 440. The function and material of the protective layer 450 are similar to those of the protective layer 250 of the first embodiment, and thus the description thereof will be omitted.

Address electrodes 460 are located on the front surface of the second substrate 420 crossing the pairs of sustain electrodes 430. A second dielectric layer 470 is formed on the address electrodes 460 and prevents the charged particles from directly colliding with and damaging the address electrodes 460.

The second dielectric layer 470 is made of the same material as the second dielectric layer 270 of the first embodiment.

Barrier ribs 480 are formed on the front surface of the second dielectric layer 470. The barrier ribs 480 built in the present embodiment have first barrier ribs 481 and second barrier ribs 482 that are arranged perpendicular to the first barrier ribs, and define the discharge cells 483 having a rectangular shape in a horizontal cross-section. However, the shape of the horizontal cross-section of the discharge cells 483 is not limited to a rectangle, and may be a polygonal shape such as a triangular or a pentagonal, or may be a closed pattern such as a circular or an elliptical shape. The shape of the discharge cells 483 in the horizontal cross-section may have an open stripe shape like the barrier ribs 280 of the first embodiment.

Grooves 490 are formed in portions of the second dielectric layer 470 which define the discharge cells 483 between the barrier ribs 480. The grooves 490 are positioned at a center between the barrier ribs 480. Each groove 490 has an edge portion 491 and a bottom portion 492, and is formed by pattern printing. A cross-section of the edge portion 491 forms a circular arc with a radius r, and the bottom portion 492 is parallel to the front surface of the second substrate 420. The cross-section of the edge portion 491 of the grooves 490 has a circular arc shape with a radius r, but the present invention is not limited to this shape. That is, the cross-section of the edge portion of the grooves may have a circular arc shape with a different radius depending upon the shape of the discharge cells. Since the shape of the edge portion 491 is symmetrical in each discharge cell 483, the shape of the groove 490 is symmetrical about a center of each discharge cell 483. The grooves 490 are not continuously formed connecting to neighboring discharge cells 483, but are formed separately in each of the discharge cells 483.

The phosphor layers 485 are formed on the side surfaces of the barrier ribs 480, and on the second dielectric layer 470 forming the discharge cells 483. The phosphor layers 485 have an ingredient which generates visible rays in response to ultraviolet rays. A red phosphor layer formed in the red light-emitting discharge cells contains a phosphor substance such as Y(V,P)O₄:Eu; a green phosphor layer formed in the green light-emitting discharge cells contains a phosphor substance such as Zn₂SiO₄:Mn; and a blue phosphor layer formed in the blue light-emitting discharge cells contains a phosphor substance such as BAM:Eu.

The phosphor layers 485 are formed by screen printing. That is, a phosphor paste is applied to the side surfaces of the barrier ribs 480, and flows down the side surfaces of the barrier ribs 480 covering the edge portions 491 and the bottom portions 492 of the grooves 490. Thereafter, the coated phosphor paste is made uniform by surface tension to form the phosphor layers 485.

At this time, the phosphor layers 485 of the plasma display panel 400 are reliable formed by the grooves 490. That is, the phosphor layers 485 formed on the bottom portions 492 of the grooves 490 are concave due to the shape of the bottom portions 492. Accordingly, no convex portion exists. In addition, the phosphor paste easily flows down the barrier ribs 480 to form phosphor layers due to the shape of the edge portions 491 having an arc-shaped section, and the thickness t₇ of the phosphor layer 485 at the top of the barrier ribs 480 is smaller than the thickness t₈ of the phosphor layers 485 at the middle portion of the barrier ribs 480. As a result, it is possible to maximize the size of the discharge space in the discharge cells 483. After the first substrate 410 and the second substrate 420 are assembled with frit glass, a discharge gas such as neon, xenon, or a mixture gas thereof is filled into the discharge cells 483.

An exemplary discharge process of the plasma display panel 400 constructed according to the second embodiment of the present invention having the above structure is described as follows.

First, when an address voltage is applied between the address electrodes 460 and the scan electrodes 432 from an external power source, address discharge is generated. Then, the discharge cells in which sustain discharge should be generated are selected as a result of the address discharge.

Thereafter, when a discharge sustain voltage is applied between the common electrode 431 and the scan electrode 432 of the selected discharge cells, a sustain discharge is created by migrations of wall charges accumulated on the common electrode 431 and the scan electrode 432. As the energy level of the discharge gas excited by the sustain discharge drops, ultraviolet rays are emitted.

The ultraviolet rays excite the phosphor substance of the phosphor layer 485 applied in the discharge cells 483. As the energy level of the phosphor substance of the phosphor layer 485 drops, visible rays are emitted. The emitted visible rays exit through the first substrate 410 to form the visible image.

Specifically, the grooves 470 of the plasma display panel 400 made according to the second embodiment make the phosphor layers 485 formed on the bottom portions 492 have an overall concave shape. Accordingly, there are no convex portions protruding into the discharge cells 483. In addition, since the thickness t₇ of the phosphor layers 485 formed at the top of the barrier ribs 480 is smaller than the thickness t₈ of the phosphor layers 485 formed at the middle portion of the barrier ribs 480, it is possible to maximize the size of the discharge spaces in the discharge cells 483. As a result, the plasma discharge becomes easier, thereby enhancing the emission brightness and the discharge efficiency.

As described above, the plasma display panel having a dielectric layer structure built according to the present invention has grooves formed in at least a part of the dielectric layer. Accordingly, the phosphor layers can be formed in the optimum shape to maximize a size of the discharge space, thereby enhancing the emission brightness and the discharge efficiency.

While the present invention has been particularly shown and described with reference to exemplary embodiments thereof, it will be understood by those skilled in the art that various changes in form and detail may be made therein without departing from the spirit and scope of the present invention as defined by the appended claims.

What is claimed is:

1. A dielectric layer structure in a plasma display panel, comprising:
a plurality of barrier ribs defining discharge cells;
a dielectric layer formed beneath the discharge cells;
a groove formed on the dielectric layer inside each of the discharge cells; and
a phosphor layer formed inside each of the discharge cells;

2. The dielectric layer structure according to claim 1, wherein the groove is centered between the barrier ribs defining the corresponding discharge cell.

3. The dielectric layer structure according to claim 1, wherein the groove has an edge portion and a bottom portion.

4. The dielectric layer structure according to claim 3, wherein the edge portion has an inclined plane formed at an angle with respect to the bottom portion.

5. The dielectric layer structure according to claim 3, wherein a cross-section of the edge portion has a step shape.

6. The dielectric layer structure according to claim 3, wherein a cross-section of the edge portion has an arc shape.

7. The dielectric layer structure according to claim 1, wherein the groove is symmetrical about a center of the discharge cell.

8. The dielectric layer structure according to claim 1, wherein the groove is continuously formed through the discharge cells.

9. The dielectric layer structure according to claim 1, wherein the groove is separately formed in each of the discharge cells.

10. A plasma display panel comprising:
a first substrate;
a second substrate disposed parallel to the first substrate;
a plurality of barrier ribs located between the first substrate and the second substrate defining a plurality of discharge cells together with the first substrate and the second substrate;
a plurality of sustain electrodes having a common electrode and a scan electrode for performing discharge in the discharge cells;
a plurality of address electrodes extending in a direction intersecting the sustain electrodes;
a dielectric layer covering the address electrodes;
a groove formed on the dielectric layer inside each of the discharge cells;
a phosphor layer formed inside the discharge cells and formed on the dielectric layer; and
a discharge gas contained in the discharge cells.

11. The plasma display panel according to claim 10, wherein the first substrate is transparent.

12. The plasma display panel according to claim 10, wherein the common electrode and the scan electrode are located inside the barrier ribs, and are spaced apart from each other.

13. The plasma display panel according to claim 10, wherein the groove is centered between the barrier ribs defining the corresponding discharge cell.

14. The plasma display panel according to claim 10, wherein the groove includes an edge portion and a bottom portion.

15. The plasma display panel according to claim 14, wherein the edge portion has an inclined plane formed at an angle with respect to the bottom portion.

16. The plasma display panel according to claim 14, wherein a cross-section of the edge portion has a step shape.

17. The plasma display panel according to claim 14, wherein a cross-section of the edge portion has an arc shape.

18. The plasma display panel according to claim 10, wherein the groove is symmetrical about a center of the discharge cell.

19. The plasma display panel according to claim 10, wherein the groove is continuously formed through the discharge cells.

20. The plasma display panel according to claim 10, wherein the groove is separately formed in each of the discharge cells.
